(19) United States
(12) Patent Application Publication
(10) Pub. No.: US 2006/0274209 A1
(43) Pub. Date: Dec. 7, 2006

(54) Method and a control device using the same for controlling a display device

(75) Inventors: Chien-Wu Yen, Science Park (TW); Tzu-Hai Chung, Science Park (TW)

Correspondence Address: BRUCE H. TROXELL, SUITE 1404, 5205 LEESBURG PIKE, FALLS CHURCH, VA, 22041, US

(73) Assignee: Coretronic Corporation

(21) Appl. No.: 11/445,330

(22) Filed: Jun. 2, 2006

(30) Foreign Application Priority Data
Jun. 3, 2005 (TW) 94118446

(51) Int. Cl. H04N 5/50; H04N 9/74

(52) U.S. Cl. 348/581; 348/569

(57) ABSTRACT

A method and a control device using the same for controlling a display device comprises the steps of: generating a full image on the screen, in which the full image is generated in response to the complete image data; next generating a frame on the full image, and adjusting a size and a position of the frame; subsequently, capturing a part of the full image in the frame to define a display image; and magnifying the display image to the same size of the screen to display on the screen. Thereby, the defect from the boundary of the full image is eliminated.

This application claims the benefit of Taiwan Patent Application Serial No. 094118446, filed Jun. 3, 2005, the subject matter of which is incorporated herein by reference.

### BACKGROUND OF THE INVENTION

(1) Field of the Invention

The invention relates to a method and a control device using the same for controlling a display device, more particularly, to a method and a control device using the same for controlling a boundary of an image producing from the display device to display on a screen.

(2) Description of the Prior Art

The “On Screen Display” (OSD) chip is applied to cathode ray tube (CRT) and liquid crystal display (LCD) to generate some special characters and figures, so that users can see some information. It is usually seen on TV and monitor of computer. When users switch one channel to the other of TV or adjust volume or image quality, TV will show the adjusted status to user on a screen through the OSD chip.

The OSD chip includes embedded application programs which can show some special characters and figures, such as volume, color tint or color contrast etc., at any position on monitor, and plays a main role in man/machine interface.

The main working principles of the CRT and the LCD are to generate a full image through horizontal and vertical synchronous signals. By the principles, the OSD chip must synchronize with the horizontal and vertical synchronous signals of the full image that are produced by original image data, so that the additional characters and the figures can be displayed at some position on the full image. At present, the positions of the characters and the figures on the full image can be moved up, down left and right, and their sizes can also be adjusted via the OSD chip.

Furthermore, the OSD chip can also be applied to a projector. For the application, the “screen” controlled by the OSD chip will be re-defined as a projecting zone of the full image that is projected on a remote curtain.

Because the display device receives external image data to display an image, the image which is generated in response to the complete image data is referred to as a “full image”. However, if the display device or the image data have defects and flaws, then the full image may have non-qualified boundary.

Please refer to FIG. 1 which shows a conventional OSD chip that can solve the non-qualified boundary of the full images 2. In the display device 10, the OSD chip can be provided with pre-set parameters to solve the aforesaid problems. Aiming at the four boundaries of the images, four boundary values are set up as shown in FIG. 1, so that a zone surrounded by four boundary lines 4 is defined as a “display image” 6. The display image 6 is filled up to be shown on the display 10, so as to remove the non-qualified boundary of the full image.

However, based on different image data, the non-qualified boundary of the full image covers different interference zones. The pre-set parameters are different in the display device produced by different manufacturers. Every time playing different image data or replacing one display device with another one, re-adjusting the four boundary values must be achieved through the OSD chip, so as to re-define the range of the display image 6, which causes a lot of inconvenience and problems. Moreover, the relations between the boundary values and the range of the display image 6 cannot be shown as numerical data, so it cannot be figured out at a glance. Thus, it must be tried several times to search for appropriate boundary values. If so, the operation procedure will be very bothering and troublesome.

Therefore, the object of the present invention is to provide a method and a control device using the same for controlling the boundary of the image on the display device, so as to solve the above-mentioned problems.

### SUMMARY OF THE INVENTION

The object of the present invention is to provide a method and a control device using the same for controlling the boundary of producing from the display device to display on a screen, the control device can select the boundaries of full image in a fast, convenient and appropriate manner, so as to display an image without non-qualified boundary.

The present invention relates to a method for controlling a display device which cooperates with a screen to display an image on the screen in response to an image data.

The method includes the steps of: generating a full image on the screen, in which the full image is generated in response to the complete image data; next generating a frame on the full image, and adjusting a size and a position of the frame; subsequently, capturing a part of the full image in the frame to define the part as a display image; and magnifying the display image to the same size of the screen to display on the screen.

The method is executed by an application program stored in a memory unit, and generates the aforesaid functions through the OSD chip.

In addition, the display device can be a projector. The screen can be defined as a projecting zone of the image that is projected on a remote curtain. The full image has a boundary corresponding to a boundary of a light valve of the projector.

Therefore, through the method and the control device of the present invention, the boundaries of the full image can be selected in a fast, convenient, and appropriate manner by utilizing a module for generating frame, a module for adjusting size of frame, a module for adjusting position of frame, utilizing the steps of generating the frame on the full image, and utilizing user's observing the size and position of the frame, so as to display the image without non-qualified boundary.

### BRIEF DESCRIPTION OF THE DRAWINGS

The present invention will now be specified with reference to its preferred embodiment illustrated in the drawings, in which:

FIG. 1 is a drawing which shows that the “On Screen Display” (OSD) system is applied to treating a full image with non-qualified boundary according to the prior art.

FIG. 2 is a drawing which shows an embodiment in which the present invention is applied to a projector;

FIG. 3 is a drawing which shows an OSD system of the present invention;

FIG. 4 is a drawing which shows a control device of the present invention;

FIG. 5 is a drawing which shows a full image and boundaries of the full image, which are displayed on a screen according to the present invention; and

FIG. 6 is a flowchart of a method carried out by the control device according to the present invention.

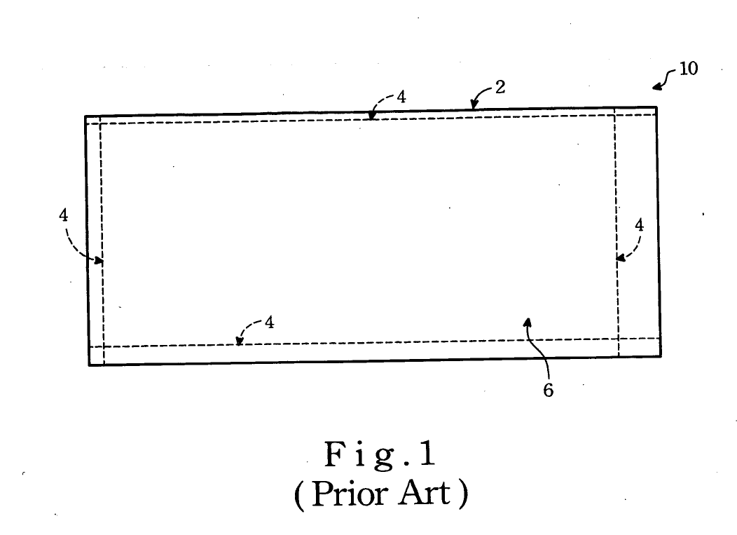

### DESCRIPTION OF THE PREFERRED EMBODIMENTS

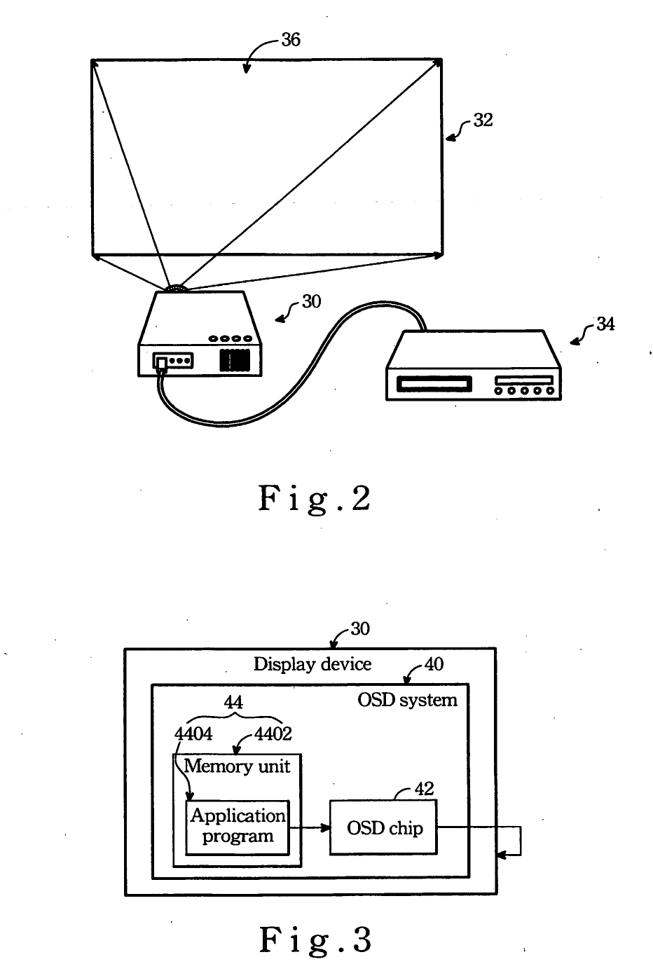

First, please refer to FIG. 2 and FIG. 3. The present invention relates to a control device 44 for controlling a display device 30, such as a projector. The display device 30 cooperates with a screen 32. Take the projector for example, the screen 32 is a projecting zone on a remote curtain (not shown) for displaying an image 36. Image data which are provided by an external play device 34, such as a DVD player, is displayed as the image 36 on the screen 32.

The control device 44 is installed in an “On Screen Display” (OSD) system 40. The OSD system 40 is installed in the display device 30. The OSD system 40 includes the control device 44 and the OSD chip 42, wherein the control device 44 includes a memory unit 4402 and an application program 4404 which is stored in the memory unit 4402, and generates relating functions through the OSD chip 42. Besides, the application program 4404 also can be embedded into the OSD chip 42.

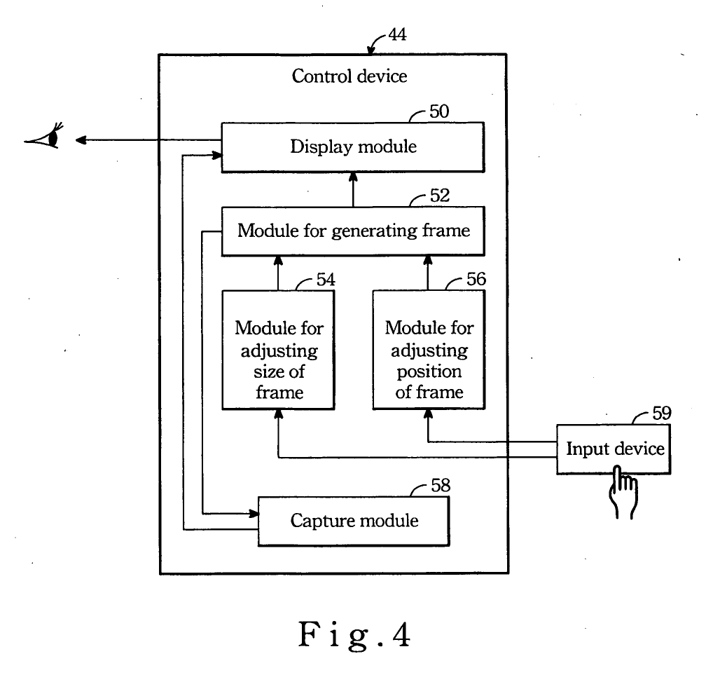

Please refer to FIG. 4 which shows the control device 44 of the present invention. The control device 44 includes a display module 50, a module 52 for generating frame, a module 54 for adjusting size of frame, a module 56 for adjusting position of frame, and a capture module 58.

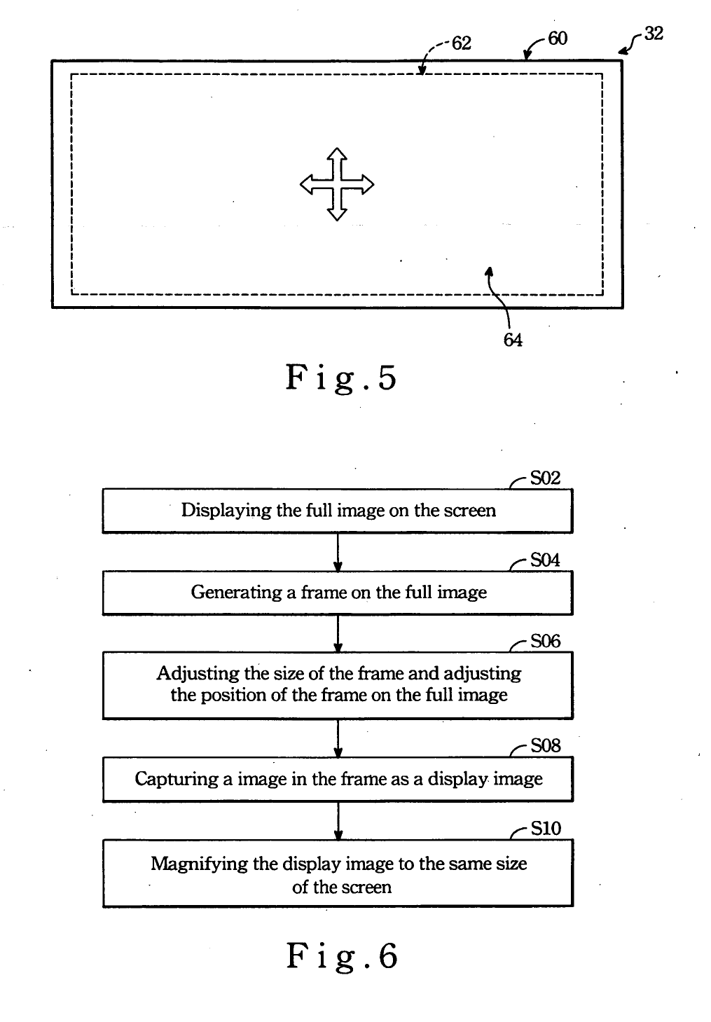

Please refer to FIG. 4 and FIG. 5. The display module 50 first displays a full image 60 on the screen 32. The full image 60 is generated in response to an complete image data to display the image 36 shown in FIG. 2. Taking the projector for example, the full image 60, as the image 36 shown in FIG. 2, has a boundary corresponding to the boundary of the light valve of the projector.

The module 52 generates a frame 62 on the full image 60. The control device 44 is externally equipped with an input device 59, such as control buttons on a housing of the projector. After a user views a non-qualified boundary of the full image 60, the user inputs relating commands through the input device 59 to control the module 54 for adjusting the size of the frame 62 that is generated by the module 52. The adjusting result is displayed through the display module 50 for the user to see.

In addition, after the user views the non-qualified boundaries of the full image 60, the user inputs relating commands through the input device 59 to control the module 56 to adjust the position of the frame 62 on the full image 60. The adjusting result is displayed through the display module 50 for the user to see.

The module 54 adjusts the size of the frame 62 and the module 56 adjusts position of frame 62 until the frame 62 is achieved an appropriate size. After the frame 62 is confirmed to be the boundary of the display image 64, the capture module 58 captures a part of the image 36 to define as a display image 64 shown in the frame 62. After the capture module 58 determines the display image 64, the display module 50 magnifies the display image 64 to the same size of the screen 32 and displays the display image 64 on the screen 32, so that the most appropriate display image 64 can be achieved in a fast, convenient manner.

Please refer to FIG. 6 which is a flowchart of a method carried out by the control device 44 according to the present invention. The control method includes the steps of:

Step (S02): generating a full image 60 on the screen 32, wherein the full image 60 is generated in response to the complete image data;

Step (S04): generating a frame 62 on the full image 60.

Step (S06): adjusting a size of the frame 62 and a position of the frame 62;

Step (S08): capturing a part of the full image 60 in the frame 62 to define the part as a display image 64; and

Step (S10): magnifying the display image 64 to the same size of the screen to display on the screen 32.

As above-mentioned, the display device 30 further includes an OSD chip, and the control method of the OSD chip is executed by the application program 4404 which is stored in the memory unit 4402, so as to generate the above functions through the OSD chip 42.

Therefore, through the method and the control device of the display device of the present invention, the boundaries of the full image can be selected in a fast, convenient, and appropriate manner by utilizing a module for generating a frame, a module for adjusting size of the frame, a module for adjusting position of the frame, utilizing the steps of generating the frame on the full image, and utilizing user's observing the size and position of the frame, so as to display the image without non-qualified boundary.

While the present invention has been particularly shown and described with reference to a preferred embodiment, it will be understood by those skilled in the art that various changes in form and detail may be

I claim:

1. A method for controlling a display device cooperating with a screen to display an image on the screen in response to an image data, the method comprising the steps of:
generating a full image on the screen, wherein the full image is generated in response to the image data;
generating a frame on the full image;
adjusting a size of the frame;
capturing a part of the full image in the frame to define a display image; and
magnifying the display image to the same size of the screen to display on the screen.

2. The method according to claim 1, wherein the step of adjusting the size of the frame further comprising: adjusting a position of the frame on the full image.

3. The method according to claim 1, wherein the display device further comprises an On Screen Display (OSD) chip.

4. The method according to claim 3, wherein the method is executed by an application program stored in a memory unit, and generates functions through the OSD chip.

5. The method according to claim 1, wherein the display device is a projector.

6. The method according to claim 5, wherein the screen is defined as a projecting zone of the image that is projected on a remote curtain.

7. The method according to claim 5, wherein the full image has a boundary corresponding to a boundary of a light valve of the projector.

8. A control device for controlling a display cooperating with a screen to display an image on the screen in response to an image data, the control device comprising:
a display module which generates a full image on the screen, wherein the full image is generated in response to a complete image data;
a module for generating a frame on the full image;
a module for adjusting size of the frame; and
a capture module which captures a part of the full image in the frame to define a display image, wherein the capture module magnifies the display image to the same size of the screen to display on the screen after capturing.

9. The control device according to claim 8, further comprising a module for adjusting position of the frame, in which the module for adjusting position of frame is used to adjust a position of the frame on the full image.

10. The control device according to claim 8, wherein the control device is applied to an On Screen Display (OSD) system of the display device, and the OSD system further comprises an OSD chip.

11. The control device according to claim 10, further comprising a memory unit and an application program stored in a memory unit.

12. The control device according to claim 8, wherein the display device is a projector.

13. The control device according to claim 12, wherein the screen is defined as a projecting zone of the image that is projected on a remote curtain.

14. The control device according to claim 12, wherein the full image has a boundary corresponding to a boundary of a light valve of the projector.
